(19) United States
(12) Patent Application Publication
(10) Pub. No.: US 2016/0361833 A1
(43) Pub. Date: Dec. 15, 2016

(54) RADIO-FREQUENCY METHODS FOR ENGINEERED WOOD PRODUCTS

(71) Applicant: FPINNOVATIONS, Pointe-Claire (CA)

(72) Inventors: Brad Jianhe WANG, Richmond (CA); Chunping DAI, Vancouver (CA)

(21) Appl. No.: 15/178,585

(22) Filed: Jun. 10, 2016

Related U.S. Application Data
(60) Provisional application No. 62/175,645, filed on Jun. 15, 2015.

(51) Int. Cl. B27N 3/18; B27N 3/20

(52) U.S. Cl. CPC B27N 3/18; B27N 3/203

(57) ABSTRACT

Radio-frequency methods for engineered wood products (EWPs), such as thick EWP products and plywood having higher moisture contents are disclosed. For thick EWP products, intermittent RF is used as the sole energy source to heat the thick EWPs. This method for thick EWPs yields a higher panel MC of 9-12% compared to 5-8% from conventional hot pressing. The RF heating process facilitates manufacturing of structural composite lumber (SCL) products including LVL, oriented strand lumber (OSL) and veneer strand lumber (VSL) in addition to sawn lumber. For plywood products, a method of using RF in pre-pressing of stack of veneer layers for preparation of plywood is developed. In a preferred embodiment a conventional cold pre-press is retrofitted with a radio-frequency (RF) generator that pre-heats the stack of veneer layers to 60-80° C. under pressure. The pre-heating allows for a final hot press at lower press temperature and higher MC within the stack.

### FIELD

Radio-frequency (RF) is disclosed as a sole energy source for thick engineered wood products particularly laminated veneer lumber (LVL) to handle high moisture content (MC) or wet pocket veneers and that without causing arcing, burning and blows during pressing and unloading. A pre-pressing method is also disclosed for plywood manufacturing by a combined cold press with an RF (Radio Frequency) pre-heating unit, and in preferred embodiment the cold press is a conventional cold press retro-fitted with RF unit.

### BACKGROUND

High frequency (HF) heating, namely radio frequency (RF) and microwave (MW), has been used for decades in the wood industry (Barnes et al.). The use of HF heating is merely a means of obtaining heat to evaporate moisture or to cure gluelines in wood-to-wood joints. RF heating has been used for lumber drying, veneer redrying, product gluing (curing of plywood, glulam and finger-joints of I-joist flanges), and preheating of thick panels before pressing. MW heating has been used successfully for making thick Parallam (Klemarewski, U.S. Pat. No. 6,287,410).

For plywood production, one of the biggest cost and quality factors for plywood products is drying and pressing veneers with high and uneven veneer moisture content (MC). Higher MC requires higher energy consumption and longer drying time to obtain a uniform MC of 3-6% for gluing using conventional processing techniques.

RF (Radio Frequency) heating technology has experienced challenges when applied to the lumber industry.

For thick engineered wood products such as, laminated veneer lumber (LVL) and cross laminated timber (CLT) these challenges include: the time required to obtain glue curing during RF gluing depends on numerous factors, such as, wood species, wood mass, area of glue lines, and temperature rise required. Two of the most common issues encountered with RF gluing are: 1) “arcing” and 2) “burning”, which are separate issues resulting from different circumstances in RF heating. Blowing can also be an issue during RF pressing, particularly when pressing high MC veneer and generally occurs during press unloading when bonding strength is inadequate to resist high steam pressure generated during pressing.

1) Arcing is generally attributed to a type of dielectric break down resulting in a black or carbonized colored tree-like pattern that extends from the top to bottom regions within a glueline cross section and usually starts at either the top or bottom edges of the glue joint. Arcing is generally caused by the formation of a highly conductive path that is parallel to the electric field between top and bottom electrodes. Sodium hydroxide in PF glue is highly conductive; therefore, in the case of plywood and laminated veneer lumber (LVL) pressing, excess glue that squeezes onto platen or open areas can cause arcing. Arcing overloads the RF generator but appropriate safeguards are generally installed to shut off power quickly before any substantial damage can be done. It is generally preferred to apply a relatively light spread of a heavy glue mix than a heavy spread of a thin mix. In this way, glue squeeze-out can be minimized to reduce the likelihood of a direct dielectric path.

2) Burning is generally caused by a high voltage gradient that develops within a small area of the panel assembly. This may be caused by various factors, such as irregularities on the wood surfaces adjacent to the glue line, peculiarities in the wood anatomy, or the adhesive complexities associated with this problem.

The means of RF heating differs from other sources. Electrical impulses or energy generated by an RF generator create frictional heat at a high frequency from 2 to 30 megacycles while passing through material. Electrical properties of the host material govern heat properties. In the case of wood, which is a reasonably good insulator, RF current uniformly heats the mass, thus the center area is heated as fast and to the same degree as outer surfaces. In theory, RF heating gives a very fast uniform temperature rise throughout the panel thickness (Torgovnikov). This is in contrast to other heat sources, like hot platen or steam, where heat transfers slowly from the surfaces to the center. As panel thickness increases, conventional platen and steaming-injection heating methods become less effective; hence, RF heating can be used to shorten pressing time. During RF heating, required glue curing time depends on numerous factors such as wood species, wood mass, area of glue lines, and the temperature rise required. Molecules in the glue that bind layers of wood together are polar like those of water, but the former are commonly much larger than the latter. When exposed to RF energy, both types of molecules vibrate and generate heat, leading to glue polymerization and curing. Depending on the arrangement of gluelines, RF heating can be classified into the following two configurations:

### a) Perpendicular Heating

This set-up is adopted to heat the entire mass of material placed between electrodes. Here, the glue lines are parallel to the electrodes but perpendicular to the flow of the RF current between electrodes. This arrangement is generally used to bond flat or curved plywood and LVL, or for laminating purposes.

### b) Parallel Heating

This set-up has the glue lines running at right angles to the electrodes, or parallel to the flow of the RF current between electrodes. Since the glue lines are normally more conductive than the wood, the current is usually concentrated into the area of the glue lines to produce a pattern of selective heating.

High-frequency heating was applied to manufacture bamboo/wood reconstituted materials using a PF impregnation resin (solids content 25%) (Zhang et al.). The radio-frequency was also used to protect wood substrate. In a constrained environment, the wood substrate was heated under pressure. At a desired time, the pressure is rapidly reduced causing any water present in the substrate to rapidly boil and convert to steam (Maynard and Bergervoet, US2008/0022548). The high-frequency heating was performed in a period with a forming pressure of 8 MPa or lower. Compared to dimension lumber, LVL and plywood have higher and more uniform stiffness and strength, greater dimension/dimensional stability, and minimum defects. One of the biggest cost factors for plywood mills processing green veneers from common softwood/hardwood species such as hemlock, amabilis fir, spruce, lodgepole pine and aspen is its high moisture content (MC) and accompanying wet pockets. Higher MC requires higher energy consumption and longer drying time to obtain a target MC of 3-6%, as required by normal gluing and pressing processes. Wet pockets in veneer normally cause significant issues such as underdrying and overdrying since it is very difficult to dry the sheet to a uniform MC.

There is a need for new pressing method for veneers of thick engineered wood products having high MC (or wet pockets), for improved drying productivity and substantial improvement of veneer quality and while reducing energy consumption. Similarly there is a need to handle higher MC and wet pockets in plywood products. Using RF to fulfill these needs is envisaged.

### SUMMARY

In accordance with one aspect herein described, there is provided an engineered wood product (EWP) production process comprising providing a multilayer panel assembly comprising glue between multilayers, loading the multilayer panel assembly into a press comprising a radio-frequency generator to produce a loaded multilayer panel assembly and pressing the loaded multilayer panel assembly; heating the loaded multilayer panel assembly with a first round of radio-frequency waves produced by the radio-frequency generator to a first temperature between 90° C. and 100° C. to produce a heated multilayer panel assembly; halting the radio-frequency waves for a predetermined time thereby bonding the multilayers with a glue-bond free of steam and producing a steam-free bonded multilayer panel assembly; heating the steam-free bonded multilayer panel assembly with a second round of radio-frequency waves to a second temperature between 90° C. and 100° C. and producing a cured multilayer panel assembly; and depressurizing the cured multilayer panel assembly with a decompression cycle to produce the engineered wood product.

In accordance with another embodiment of the process herein described, wherein the first and the second temperature is between 90° C. and less than 100° C.

In accordance with another embodiment of the process herein described, wherein the engineered wood product is a structural composite lumber (SCL) product.

In accordance with another embodiment of the process herein described, wherein the structural composite lumber (SCL) product is a thick wood product selected from the group consisting of laminated veneer lumber (LVL), oriented strand lumber (OSL), and veneer strand lumber (VSL).

In accordance with another embodiment of the process herein described, wherein the predetermined time for halting the radio-frequency waves is 2 to 4 minutes.

In accordance with another embodiment of the process herein described, wherein the predetermined time for halting the radio-frequency waves is 2 minutes.

In accordance with another embodiment of the process herein described, wherein the second round of radio-frequency wave is shorter than the first round of radio-frequency waves.

In accordance with another aspect herein described, there is provided an engineered wood product comprising an overall final moisture content of 9 to 12% by weight and a thickness from 3.5 inches to 6 inches.

In accordance with another embodiment of the engineered wood product comprising an overall final moisture content of 10 to 12% by weight.

In accordance with another embodiment of the engineered wood product comprising an overall final moisture content of 11 to 12% by weight.

In accordance with another embodiment of the engineered wood product herein described, wherein the product is a laminated veneer lumber comprising between 8 and 15 veneer layers.

In accordance with another embodiment of the engineered wood product herein described wherein the laminated veneer lumber herein described, comprising between 10 and 13 veneer layers.

In accordance with another aspect herein described, there is provided a plywood production process comprising clipping, dried and resin-coated veneer layers in a pre-press comprising a radio-frequency generator to produce a stack of veneer layers; pre-pressing the stack of veneer layers in the pre-press to a temperature of 50° C. to 90° C. while exposing the stack of veneer layers to radio-frequency waves produced by the radio-frequency generator to produce a preheated stack; and pressing the preheated stack in a heated press at a temperature from 100° C. to 200° C.

In accordance with another embodiment of the plywood production process herein described, wherein the temperature in the pre-press is 60° C. to 80° C.

In accordance with another embodiment of the plywood production process herein described, wherein the temperature in the heated press is 140° C. to 160° C.

In accordance with another embodiment of the plywood production process herein described, wherein the radio-frequency generator has a power range of about 20 to about 70 kW.

In accordance with another embodiment of the plywood production process herein described, wherein the power range of about 30 to 60 kW.

In accordance with another embodiment of the plywood production process herein described, wherein the pre-pressing is 2 to 4 minutes long.

In accordance with another aspect herein described, there is provided a plywood production plant comprising a pre-press comprising an upper platen, an lower platen, and a radio-frequency generator, the pre-press pre-pressing a stack of veneer layers to a temperature of 50° C. to 90° C. between the upper platen and the lower platen while exposing the stack of veneer layers to radio-frequency waves produced by the radio-frequency generator.

In accordance with another embodiment of the plant herein described, wherein the press is a convention pre-press and the radio-frequency generator is a retrofitted radio-frequency generator placed on the pre-press.

In accordance with another embodiment of the plant herein described, wherein the radio-frequency generator has a power range of about 20 to about 70 kW.

In accordance with another embodiment of the plant herein described, wherein the power range of about 30 to 60 kW.

In accordance with yet another embodiment of the plant herein described, wherein the upper platen is electrically grounded.

### BRIEF DESCRIPTION OF THE DRAWINGS

FIG. 1 is a block diagram of the process using RF as a sole energy source for thick engineered wood products (EWP) according to one embodiment herein described;

FIG. 2 illustrates a schematic of an RF pre-heating pressure for plywood according to one embodiment herein described, where a conventional pre-press is retrofitted;

FIG. 3 is a bar chart comparison of wood failure percentage for nine (9) plywood samples with a 6% w/w veneer moisture content; and

FIG. 4 is a bar chart comparison of wood failure percentage for seven (7) plywood samples with a 10% w/w veneer moisture content.

### DETAILED DESCRIPTION

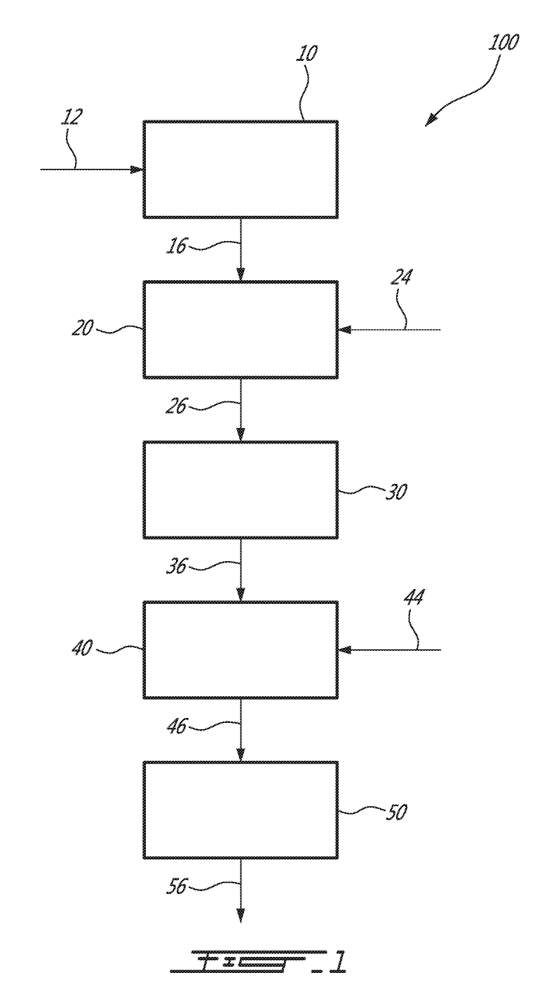

FIG. 1 illustrates the process 100 for producing thick engineered wood products (EWP) such as structural composite lumber (SCL) products including laminated veneer lumber (LVL), oriented strand lumber (OSL), veneer strand lumber (VSL). The inventors have discovered that there is no significant difference in mechanical properties between conventionally hot platen pressed LVL and high frequency pressed LVL.

A multi-layer panel assembly 12 is provided for the process 100. The method of making a multi-layer panel assembly is known to the skilled practitioner, and includes the steps of obtaining a plurality of veneer layers by peeling, clipping and cutting. The multilayers are provide with glue between inner layers and are adapted to fit into a press where the assembly 12 is pressed 10 together under high pressure.

A present RF pressing process illustrated in FIG. 1 is used as a sole energy source and is effective at handling and overcoming difficulties caused by high moisture content (MC) or wet pocket veneers and that without causing arcing, burning and blows during pressing and unloading. An intermittent schedule of RF application developed/optimized by the present inventors, for various variables including: species, veneer MC and panel lay-up. Interestingly, compared to conventional hot pressing, the RF pressing schedules of the present process can reduce pressing time and glue spread, and that while maintaining high quality panel glue bonding. This RF heating method 100 is applicable to both regular PF resin and lignin PF resin (LPF).

The process 100 combines a species-dependant pressure with an intermittent RF heating recipe to avoid glue squeeze-out and overheating. The process 100 also successfully handles high sodium hydroxide in the commercial phenol formaldehyde (PF) resin and lignin phenol formaldehyde (LPF) resin.

The RF pressing process 100 described herein comprises of the following steps/unit operation most of which occur within a press that includes a RF generator:
1. A multi-layer panel assembly 12 is loaded/pressed 10 into the press. The press is quickly closed and the assembly 12 pressed to create a close contact between veneer (or strand) elements under a specific pressing pressure, and thereby producing a pressed multilayer panel assembly 16;
2. The pressed multilayer panel assembly 16 is heated 20 when by a first round of RF energy waves 24 for a pre-determined heating time, which is determined according to the mass of the assembly, the wood species, veneer MC, the temperature to which the assembly should be raised, and power of the RF generator. This RF heating produces a first round RF heated multilayer assembly 26;
3. When the temperature within the multilayer assembly is attained, that in a preferred embodiment is just below 100° C., the induced RF energy is halted 30 for a predetermined time to allow the temperature the assembly inside to dissipate. By controlling the temperature under the 100° C. temperature barrier, the glue cures/bonds at a higher rate without the presence of steam, or is “stream-free” bonded. A steam-free bonded multilayer panel assembly 36 is produced at this stage. The combination of temperature and time without RF produces a panel bonding strength that develops quickly, resulting in higher bond quality. Temperature within the panel assembly also tends to distribute more uniformly when RF energy is stopped for a short period of time and avoids problems such as glue squeeze-out and arcing during pressing.
4. Once sufficient bonding is developed with the assembly 36, a second round of RF heating 40 via a second round of RF waves 44 is re-introduced to the assembly 36 to further cure the glue. Consequently, high panel glue bond/cure is achieved with shorter pressing times and less energy consumption and without causing blowing (i.e. steam release) from the panel assembly. The second round of RF heating 40 is generally half or a third the length of time of the first round of RF 20.
5. Finally, a short decompression cycle 50 is introduced to unload the press for degassing and to eliminate potential blows, and thereby produce the thick engineered wood product 56.

When the process 100 is compared to conventional hot pressing, this RF pressing process 100 can reduce pressing time by at least 30% and glue spread by at least 10%, while maintaining high quality panel glue bond. More reduction in pressing time can be achieved if an RF generator with a higher power output is used. Additional benefits include less stringent requirements of dry veneer MC, leading to increased drying productivity, improved dry veneer quality, and reduced drying energy consumption. The new method further yields a thick EWP panel having a higher MC in the range from of 7-12% by weight as compared to 5-8% by weight from conventional hot pressing. The thick EWP produced in a preferred embodiment has a moisture content of from 9 to 12% by weight, more preferably 10 to 12% by weight, and most preferably 11 to 12%. The thick EWPs herein described are under or have a thickness of 3.5 to 6 inches in a preferred embodiment. These higher MC levels coupled with the EWP thicknesses are known to cause processing problems with standard conventionally hot platen pressed production methods. The higher panel MC will allow the manufacturing of cross-laminated timber (CLT) without involving MC adjustment for gluing. Additional benefits to higher MC level in the EWPs include: less stringent requirements of dry veneer MC, leading to increased drying productivity, improved dry veneer quality, and reduced drying energy consumption. The higher panel MC will allow the manufacturing of cross-laminated timber (CLT) without involving MC adjustment for gluing. The new RF heating process can successfully deal with regular PF resin and lignin PF (LPF) resin for the same benefits. It will facilitate the manufacturing of more structural composite lumber (SCL) products including LVL, oriented strand lumber (OSL) and veneer strand lumber (VSL) rather than just sawn lumber from available resource such as second-growth plantations or underutilized species including hemlock, amabilis fir, aspen and hybrid poplar.

Case Study B: RF Pressing with Regular Phenol Formaldehyde (PF) Adhesive

To investigate the RF heating for LVL manufacturing, 13-ply hem-fir LVL were manufactured with the following four veneer MC levels: 1) regular 6%; 2) uniformly high 12%; 3) wet pocket veneer with up to 15% MC peak; and 4) a mixture of wet pocket veneer and regular veneer. To attain a target equilibrium MC of 12% MC, hem-fir veneer sheets were conditioned in a humidity chamber for a week before pressing. Initial trials on 13-ply hem-fir LVL with continuous heating for 10 min yielded arcing and blowing. To avoid arcing and blows during RF pressing, as shown in Table 2, different pressing schedules, based on intermittent RF heating, were used to press 13-ply hem-fir LVL. A regular PF glue for plywood manufacturing was used with a solids content of 55%. To reduce the chance of glue squeeze out and thus the potential arcing, a light glue spread level in an amount of 30 lb/1000 ft² per single glueline was used. Pressure control was applied during pressing. Total pressing time was recorded for each LVL billet, and compared to conventional 13-ply hem-fir LVL pressing cycle. After pressing, each billet was stacked for 48 hours before it was cut into specimens to examine LVL longitudinal shear strength/wood failure, bending modulus of elasticity (MOE), and modulus of rupture (MOR) in both flatwise and edgewise modes.

TABLE 2
RF pressing of 13-ply hem-fir LVL with different veneer MCs

| | | | Pressing cycle | | | | | |
|---|---|---|---|---|---|---|---|---|
| | | | Press | 1^{st} RF | Time to | 2^{nd} RF | | Total |
| | | Pressing | closing | heating | keep | heating | Decompression | pressing |
| Test | Veneer MC | pressure | time | time | pressure | time | time | time |
| no. | (%) | (psi) | (min) | | | | | (min) |
| 1 | 6% | 210 | 0.5 | 6 | 2 | 2 | 2 | 12.5 |
| | | 210 | | | | 4 | 2 | 14.5 |
| 2 | 12% | 200 | 0.5 | 6 | 2 | 2 | 2 | 12.5 |
| | | 200 | | 6 | 2 | 4 | 2 | 14.5 |
| | | 200 | | 7 | 2 | 2 | 2 | 13.5 |
| 3 | Wet pocket | 180 | 0.5 | 6 | 2 | 2 | 2 | 12.5 |
| | with a 15% | 180 | | | | 4 | 2 | 14.5 |
| | peak MC | | | | | | | |
| 4 | Mixture of | 190 | 0.5 | 6 | 2 | 2 | 2 | 12.5 |
| | 6% MC | | | | | | | |
| | and wet | | | | | | | |
| | pocket | | | | | | | |
| | veneer | | | | | | | |

Table 3 summarizes the physical properties of 13-ply hem-fir LVL made with RF heating. Use of the new pressing schedules resulted in no arcing, burning, or blowing occurring during pressing of LVL billets assembled with various MC levels of veneers bonded with a regular PF glue. RF heating can successfully handle high veneer MC and a large within-sheet MC variation (wet pockets). Since final veneer MC requirements of RF pressing are not as stringent as conventional platen pressing, significant energy savings from drying could also be realized. In the meantime, dry veneer quality could be improved since veneer can be dried at a higher MC target. In this case, veneer overdrying could be largely avoided to increase panel gluebond quality. Compared to control hem-fir LVL made from 3-5% MC veneer, the final MC of LVL made with RF pressing was relatively higher (9 to 12%), which helps reduce moisture absorption during product storage, shipping, and construction. In addition, this high MC range entails the LVL to be directly laminated with structural lumber to make new engineered wood products such as cross-laminated timber (CLT). Total RF pressing time was 12.5 to 14.5 min compared to 18-22 min for conventional hot-platen pressing. As a result, the pressing time can be shortened by more than 30% if RF heating is used. More reductions in pressing time can be realized if RF generator power is increased (current power output is 5 kW only).

TABLE 3
Physical properties of 13-ply hem-fir LVL

| | | | Total | | | | |
|---|---|---|---|---|---|---|---|
| | | Pressing | pressing | Panel | Panel | Panel | Arcing/ |
| Test | Veneer | cycle | time | thickness | MC | density | burning/ |
| no. | MC (%) | (min) | (min) | (mm) | (%) | (g/cm³) | blowing ? |
| 1 | 6 | 0.5 + 6 + 2 + 2 + 2 | 12.5 | 38.5 | 10.4 | 0.469 | No |
| | | 0.5 + 6 + 2 + 4 + 2 | 14.5 | 36.7 | 10.7 | 0.509 | No |
| 2 | 12 | 0.5 + 6 + 2 + 2 + 2 | 12.5 | 35.6 | 10.2 | 0.448 | No |
| | | 0.5 + 6 + 2 + 4 + 2 | 14.5 | 38.7 | 11.7 | 0.508 | No |
| | | 0.5 + 7 + 2 + 2 + 2 | 13.5 | 38.9 | 11.2 | 0.494 | No |
| 3 | Wet | 0.5 + 6 + 2 + 2 + 2 | 12.5 | 41.1 | 12.0 | 0.485 | No |
| | pockets | 0.5 + 6 + 2 + 4 + 2 | 14.5 | 40.5 | 9.8 | 0.472 | No |
| | up to | | | | | | |
| | 15% | | | | | | |
| 4 | Mixed | 0.5 + 6 + 2 + 2 + 2 | 12.5 | 40.0 | 10.6 | 0.468 | No |
| | wet | | | | | | |
| | pockets | | | | | | |
| | and 6% | | | | | | |

| | | | | | |
|---|---|---|---|---|---|
| Mean for | 13.5 | 38.8 | 10.8 | 0.482 | No |
| RFpressing | | | | | |
| Mean for | 20.0 | 38.1 | 8.5 | 0.431 | No |
| conventional | | | | | |
| pressing (control | | | | | |
| LVL made from | | | | | |
| 3-5% MC) | | | | | |

Table 4 summarizes the mechanical properties of 13-ply hem-fir LVL. Overall, compared to the control LVL made with conventional platen pressing, RF pressed LVL yielded satisfactory bending and shear performance. With the RF pressing, both LVL edgewise bending MOE and MOR values were higher than their flatwise counterparts, which is normally the opposite to results obtained from conventional platen pressing. During RF pressing, heat was more uniformly distributed in the assembly and concentrated at the glueline. Thus, unlike the conventional platen pressing, LVL surface densification was much smaller as outer areas received less heat. Due to relatively higher densification in the core from RF pressing, the shear strength of LVL made using RF pressing was also higher than that of control billets. Wood failure results from RF pressed L-X shear specimens were comparable to those from the conventional pressing. Compared to the glue spread used for conventional platen pressing (35 lb/1000 ft² per single glueline), RF pressing used a lighter spread (30 lb/1000 ft² per single glueline), yielding an approximately 15% reduction in glue consumption.

TABLE 4
Mechanical properties of 13-ply hem-fir LVL

| | | LVL edgewise | | | | Shear strength | |
|---|---|---|---|---|---|---|---|
| | | bending | | LVL flatwise bending | | | Wood |
| Test | Veneer MC | MOR | MOE | | MOE | | failure |
| no. | (%) | (psi) | (MMpsi) | MOR (psi) | (MMpsi) | L-X (psi) | (%) |
| 1 | 6 | 8639.0 | 1.55 | 7446.5 | 1.35 | 819.2 | 93.3 |
| | | 8899.5 | 1.65 | 6899.0 | 1.70 | 942.5 | 95.0 |
| 2 | 12 | 8540.5 | 1.64 | 7735.5 | 1.43 | 557.7 | 93.3 |
| | | 9556.0 | 1.82 | 9416.0 | 1.70 | 641.1 | 93.3 |
| | | 10018.5 | 1.80 | 8325.5 | 1.72 | 714.9 | 95.0 |
| 3 | Wet pocket | 8098.5 | 1.52 | 6233.0 | 1.32 | 945.9 | 90.0 |
| | up to 15% | 7241.0 | 1.37 | 7592.5 | 1.43 | 1375.6 | 100.0 |
| 4 | Mixed wet | 7960.0 | 1.53 | 7864.0 | 1.45 | 904.9 | 90.0 |
| | pocket and | | | | | | |
| | 6% | | | | | | |

| | | | | | | |
|---|---|---|---|---|---|---|
| Mean for | 8619.0 | 1.61 | 7689.0 | 1.51 | 862.3 | 93.7 |
| RFpressing | | | | | | |
| Mean for | 8056.0 | 1.49 | 9165.0 | 1.63 | 777.0 | 95.0 |
| conventional | | | | | | |
| pressing (control | | | | | | |
| LVL made from 3-5% | | | | | | |
| MC) | | | | | | |

The above results demonstrate that the RF pressing can successfully deal with high MC veneer and wet pocket veneer. It is feasible for LVL manufacturing that uses a regular PF glue, which will lead to higher pressing efficiency and lower glue and energy consumption. RF pressed LVL has a slightly higher final MC and is more suitable for edgewise applications such as headers and beams than flatwise applications.

Case Study C: RF Pressing with Lignin PF (LPF) Adhesive

Green white spruce veneer sheets were obtained from a BC plywood mill and then dried at 165° C. for 5 min to a target average MC of 6%. These sheets were then cut into 34×24-in to make 13-ply LVL using lignin PF with RF pressing. The lignin PF was prepared by a post mixing method. The replacement ratio of PF neat resin with lignin was 20% on a weight basis. The spread of lignin PF for LVL was 35 lb/1000 ft² per single glue line. Three 13-ply LVL billets were pressed with RF heating using a 13-min pressing cycle, namely, 0.5 min-closing+6 min-heating+2 min-halting+3 min-reheating+1.5 min-decompression. In the meantime, three control 13-ply LVL billets were made with conventional pressing using the following pressing parameters: pressure 175 psi, target innermost glueline temperature 105 ° C. It was noticed that there was no arcing and burning with RF pressing using lignin PF, and the average pressing time with convention platen pressing was 18.5 min. Compared with conventional platen pressing, the average reduction in pressing time with RF pressing was approximately 30%. After pressing, all the billets were stacked and stored for 48 hours before cutting samples. Four edgewise and flatwise bending samples each, as well as 6 delamination specimens, were cut from each billet. The delamination test was conducted in accordance with CSA-0122-06 standard. Measurements were taken along the gluelines on each cross-section of the specimen. The total delamination of a specimen was calculated, which was expressed the proportion of the delamination length of all glue lines compared to the total length of all the gluelines of a specimen. Delamination was measured to an accuracy of 0.1 mm. This value was compared to the upper limit allowed by the European standards, i.e. 10% fir tropical hardwoods. The test results were summarized in Table 5.

TABLE 5
Performance of spruce LVL pressed with lignin PF

| | Flatwise | | | | | |
|---|---|---|---|---|---|---|
| | bending | | Edgewise bending | | | |
| 13-ply | | MOE | | MOE | Delamination | |
| spruce | MOR | (million | MOR | (million | rate (%) | |
| LVL | (psi) | psi) | (psi) | psi) | Measured | Target |
| RF-pressed | 11160 | 1.86 | 10974 | 1.96 | 0.6% | <=10% |
| | (1087) | (0.125) | (757) | (0.071) | | |
| Conventional | 9308 | 1.71 | 10338 | 1.77 | 2.3% | <=10% |
| (platen- | (2473) | (0.088) | (832) | (0.072) | | |
| pressed) | | | | | | |

Based on Table 5, there was no significant difference in bending MOE and MOR between RF-pressed and conventional platen pressed LVL when lignin PF was used. Delamination tests showed that RF pressing using lignin PF can also pass the standard requirements with a mean delamination rate much lower than 10%. Using the lignin PF, same amount of reduction in pressing time can be achieved without sacrificing panel bending and bonding performance.

RF has applications for thinner products such as Plywood—The pre-heating and pre-pressing process describe herein is unique and has been found surprisingly forgiving in processing higher and more variable moisture veneers. An RF heating unit can be applied by retrofitting to an existing cold pre-press. Therefore with the proposed plywood production process no significant alterations are needed to existing plywood manufacturing process. Successful implementation in real manufacturing processes can lead to substantial savings in manufacturing costs and improvement in product (glue bond) quality.

Instead of being pre-pressed at ambient temperatures, plywood veneer stacks will be pressed to 50-90° C. and preferably 60-80° C. before being fed to conventional hot pressing. This will allow for plywood to be made at much higher MC (moisture content) while improving bond quality. This production method including a pre-pressing with RF reduces production costs, while improving product quality.

Plywood panel products manufacturing typically consists of following steps:
1. peeling logs into veneer sheets,
2. cutting veneer sheet into 4 ft by 8 ft size,
3. drying the cut veneer sheets to an average MC of 3-6%,
4. coating veneers with glue/resin,
5. laying up stack veneer layers,
6. pre-pressing stacks of veneer layers at ambient temperatures,
7. pressing veneer stacks into solid panels using a hot platen press, and
8. trimming and finishing.

The present description mainly concerns Steps 6 and 7. Instead of pre-pressing at ambient conditions, an RF heating unit is added, allowing veneers to be heated while under pressure. The desired veneer temperature is 60-80° C. This pre-pressing process can use PF resin and lignin PF (LPF) resin, to produce the same benefits. The heat and closed assembly time help moisture inside the veneers to distribute more uniformly without causing glue dry-out. The pre-heating allows veneers to be pressed in the final hot press at significantly lower press temperature and higher moisture content without glue delamination and lowering productivity.

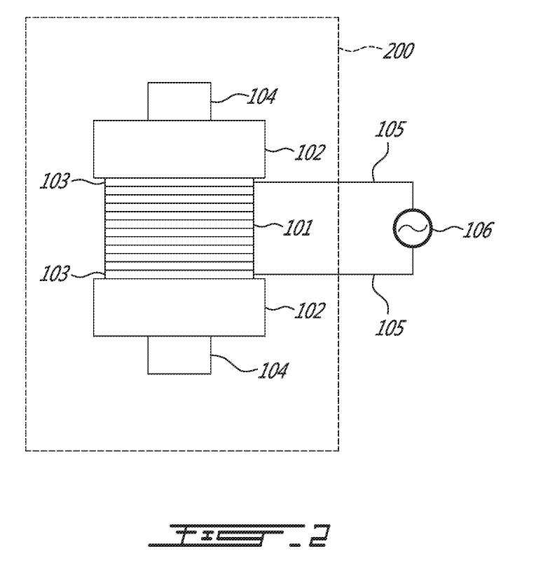

As shown in FIG. 2, a stack of veneer layers 101 are loaded into a conventional plywood pre-press 200 with an RF generator. The stack of veneer layers 101 is generally cut to a specific size suited for the pre-press. This step of cutting a long veneer ribbon into veneer sheets of a predetermined width (in a preferred embodiment 4 ft.), and a length (preferably 8 ft.) is called “clipping”. These clipped sheets can be pre-dried before pre-pressing to a certain level of humidity and, coated with an adhesive. This preferably clipped, dried and coated stack of veneer layers 101 are transferred to the pre-press.

The pre-press may be one that has RF or in a preferred embodiment is a conventional pre-press that has been modified to perform RF heating. Two electrodes 103 are attached to the platens 102 of the pre-press and with wires 105 to an RF generator 106, with the upper electrode of the pre-press preferably grounded. The pressure ram 104 is applied and the stack veneer layers 101 is pressed together to create initial tack (bond) while applying RF energy.

The target temperature for the veneer stack is 50-90° C., and preferably 60-80° C. with a time of 2-4 minutes for pre-pressing. Depending on the number of veneer layers, the power of the RF generator should be in the range of about 20 to about 70 kW, and preferably about 30 to about 60 kW. After heating the stack for 2-4 minutes, the pre-press is opened and each veneer assembly is fed into an opening of the hot press.

Due to this preheating, the platen temperature can be maintained the same as conventional hot pressing, namely about 150° C. but will reduce the pressing time. Alternatively, the platen temperature can be reduced to allow higher moisture veneer to be pressed without causing blows or panel delamination.

Case Study A—with 5-Ply Hemlock Plywood:

To examine RF preheating for plywood manufacturing, 4×8-ft freshly dried ⅛-in thick hemlock veneer sheets were cut into 12×12-in sheets and then conditioned to two MC groups, 6% and 10%. A 5 kW RF generator was hooked onto a laboratory 3×3-ft press for plywood manufacturing.

Table 6 shows the experimental design for RF pre-heating 5-ply hemlock plywood. Three 5-ply plywood assemblies with a PF glue spread of 30 lb/1000 ft² per single glue line were stacked, and preheated by RF for 3 min with 200 psi pressure. After preheating, panels were unloaded and the centre panel was further pressed by 150° C. hot platen with a 200 psi pressure for 3 min. Control tests were done with conventional platen pressing and single RF pressing. The glue spread was 30 lb/1000 ft² per single glue line for single RF pressing and 32 lb/1000 ft² for conventional platen pressing. After pressing, all panels were conditioned for 48 hours before cuttings 10 shear samples from each panel. The shear strength and wood failure percentage of each sample were measured.

TABLE 6
Experimental design of RF preheating for 5-ply hemlock plywood

| | | | | Hot | Applied |
|---|---|---|---|---|---|
| Test | Pressing | Veneer | RF heating | pressing | pressure |
| Ref. | conditions | MC (%) | time (min) | time (min) | (psi) |
| A | RF + Platen L1 | Regular | 3.0 | 3.0 | 200 |
| B | RF + Platen L2 | dry MC | 3.0 | 3.0 | 200 |
| C | RF + Platen L3 | (6%) | 3.0 | 3.0 | 200 |
| D | Platen 1 | | 0 | 4.5 | 200 |
| E | Platen 2 | | 0 | 5.0 | 200 |
| F | Platen 3 | | 0 | 5.5 | 200 |
| G | RF L1 | | 4.5 | 0 | 200 |
| H | RF L2 | | 5.0 | 0 | 200 |
| I | RF L3 | | 5.5 | 0 | 200 |
| J | RF + Platen H1 | High MC | 3.0 | 3.0 | 200 |
| K | RF + Platen H2 | (10%) | 3.0 | 3.0 | 200 |
| L | RF + Platen H3 | | 3.0 | 3.0 | 200 |
| M | Platen 1 | | 0 | 4.5 | 200 |
| N | Platen 2 | | 0 | 5.0 | 200 |
| O | Platen 3 | | 0 | 5.5 | 200 |
| P | RF H1 | | 4.5 | 0 | 200 |
| Q | RF H2 | | 5.0 | 0 | 200 |
| R | RF H3 | | 5.5 | 0 | 200 |

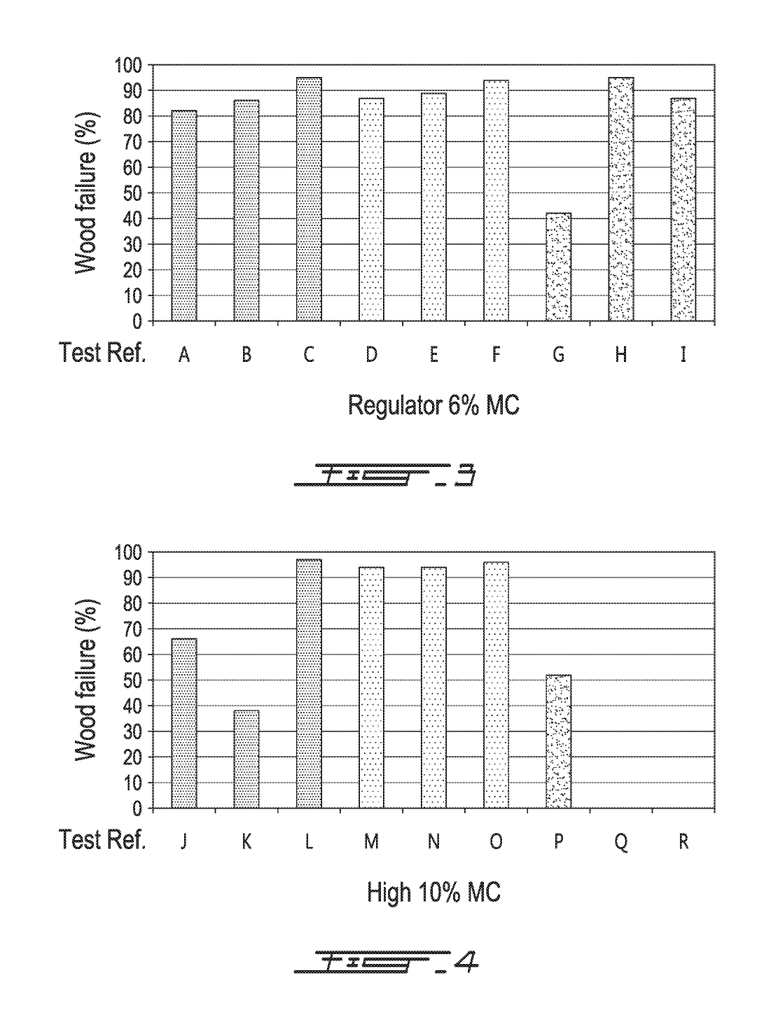

FIG. 3 shows the comparison of wood failure percentage among 9 cases (Test Ref. A through I) with regular 6% veneer MC from Table 6. FIG. 3 demonstrates that the combination of 3 min RF with 3 min hot platen pressing yielded a wood failure greater than 80%. With conventional pressing, the wood failure was lower than 80% when pressing for 4.5 min. The required pressing time for 5-ply plywood was 5.0 min. As a result, the reduction in pressing time was about 40%.

FIG. 4 shows the comparison of wood failure percentage among 9 cases (Test Ref. J through R) with 10% veneer MC from Table 6. It demonstrated that 2 out of 3 panels pressed with conventional hot pressing method had “blows” (delamination). By comparison, 2 out of 3 panels pressed with a combination of preheating and heating yielded decent wood failures and none had “blows”. It is expected that if the hot pressing time is extended from 3 min to 4 min, the wood failure could be significantly improved. The results show that the plywood preheating help process the high moisture veneer or wet pocket veneer without causing delamination, which leads to additional benefits from reduced drying energy consumption, improved veneer quality and increased recovery.

### REFERENCES

Barnes, D., L. Admiral, R. L. Pike and V. N. P. Mathur. 1976. Continuous system for the drying of lumber with microwave energy. Forest Products Journal. 1976, 26(5).

Klemarewski, A. 2001. System and method for making compressed wood product. U.S. Pat. No. 6,287,410.

Maynard, N. P. and A. J. Bergervoet. 2008. Wood preservation by radio frequency Heating. US Patent Appl. US20080022548.

Torgovnikov, G. I. 1993. Dielectric properties of wood and wood based materials. Springer Verlag Berlin. 199 pp.

Zhang, Q. S., S. X. Jiang, H. Lin, G. J. Mu, Q. M. Zhu, Y. X. Chen, J. H. Zhou, X. H. Xiong and Z. Q. Zeng. 2012. Method for manufacturing bamboo/wood reconstitute material through high-frequency heating. China Patent No. CN102320068.

1. An engineered wood product (EWP) production process comprising:
providing a multilayer panel assembly comprising glue between multilayers,
loading the multilayer panel assembly into a press comprising a radio-frequency generator to produce a loaded multilayer panel assembly and pressing the loaded multilayer panel assembly;
heating the loaded multilayer panel assembly with a first round of radio-frequency waves produced by the radio-frequency generator to a first temperature between 90° C. and 100° C. to produce a heated multilayer panel assembly;
halting the radio-frequency waves for a predetermined time thereby bonding the multilayers with a glue-bond free of steam and producing a steam-free bonded multilayer panel assembly;
heating the steam-free bonded multilayer panel assembly with a second round of radio-frequency waves to a second temperature between 90° C. and 100° C. and producing a cured multilayer panel assembly; and
depressurizing the cured multilayer panel assembly with a decompression cycle to produce the engineered wood product.

2. The process of claim 1, wherein the first and the second temperature is between 90° C. and less than 100° C.

3. The process of claim 1, wherein the engineered wood product is a structural composite lumber (SCL) product.

4. The process of claim 3, wherein the structural composite lumber SCL product is a thick wood product selected from the group consisting of laminated veneer lumber (LVL), oriented strand lumber (OSL), and veneer strand lumber (VSL).

5. The process of claim 1, wherein the predetermined time for halting the radio-frequency waves is 2 to 4 minutes.

6. The process of claim 1, wherein the second round of radio-frequency wave is shorter than the first round of radio-frequency waves.

7. An engineered wood product comprising an overall final moisture content of 9 to 12% by weight and a thickness from 3.5 inches to 6 inches.

8. The engineered wood product of claim 7 comprising an overall final moisture content of 10 to 12% by weight.

9. The engineered wood product of claim 7 comprising an overall final moisture content of 11 to 12% by weight.

10. The engineered wood product of claim 7, wherein the product is a laminated veneer lumber comprising between 8 and 15 veneer layers.

11. A plywood production process comprising:
clipping, dried and resin-coated veneer layers in a pre-press comprising a radio-frequency generator to produce a stack of veneer layers;
pre-pressing the stack of veneer layers in the pre-press to a temperature of 50° C. to 90° C. while exposing the stack of veneer layers to radio-frequency waves produced by the radio-frequency generator to produce a preheated stack; and
pressing the preheated stack in a heated press at a temperature from 100° C. to 200° C.

12. The process of claim 11, wherein the temperature in the pre-press is 60° C. to 80° C.

13. The process of claim 11, wherein the temperature in the heated press is 140° C. to 160° C.

14. The process of claim 11, wherein the radio-frequency generator has a power range of about 20 to about 70 kW.

15. The process of claim 14, wherein the power range of about 30 to 60 kW.

16. The process of claim 11, wherein the pre-pressing is 2 to 4 minutes long.

17. A plywood production plant comprising
a pre-press comprising
an upper platen, an lower platen, and a radio-frequency generator,
the pre-press pre-pressing a stack of veneer layers to a temperature of 50° C. to 90° C. between the upper platen and the lower platen while exposing the stack of veneer layers to radio-frequency waves produced by the radio-frequency generator.

18. The plant of claim 17, wherein the pre-press is a convention pre-press and the radio-frequency generator is a retrofitted radio-frequency generator placed on the pre-press.

19. The plant of claim 17, wherein the radio-frequency generator has a power range of about 20 to about 70 kW.

20. The plant of claim 19, wherein the power range of about 30 to 60 kW.
